(19) United States
(12) Patent Application Publication
(10) Pub. No.: US 2014/0342780 A1
(43) Pub. Date: Nov. 20, 2014

(54) System and apparatus for expanding the capability of existing land mobile radio systems by embedding a wireless modem together with a processor, memory and one or more external interfaces, into a speaker microphone that attaches to a land mobile or portable radio. The wireless data modem is then used to communicate with external data servers

(71) Applicant: Gary A. Ruegg, Mesa, AZ (US)

(72) Inventor: Gary A. Ruegg, Mesa, AZ (US)

(21) Appl. No.: 14/121,122

(22) Filed: Dec. 6, 2012

(51) Int. Cl. H04M 1/03; H04M 1/02

(52) U.S. Cl. CPC H04M 1/03; H04M 1/026
USPC 455/566; 455/550.1

(57) ABSTRACT

A system and apparatus for expanding the capability of existing land mobile radio systems by embedding a wireless modem together with a processor, memory and one or more external interfaces, into a speaker microphone that attaches to a land mobile or portable radio. The wireless data modem is then used to communicate with external data servers.

### TECHNICAL FIELD

The invention generally relates to communication systems and more particularly to mobile data access.

### BACKGROUND ART

Various individuals have provided means to enhance radio system and more specifically first responder safety and efficiency. The industry is moving to combine the advantages of 3G and LTE technologies into a new generation of communication device.

### SUMMARY OF INVENTION

### Technical Problem

Radio system users require the ability to transmit and receive data in addition to voice. Whether the data is location, sensor readings, images, or documents. The investment in radios systems has already been made; with this invention the investment in existing radio systems is protected as any radio system is upgradeable.

### Solution to Problem

Operationally it is impractical to use a separate land mobile radio and the data side of a smart phone simultaneously without a device that provides adequate volume for the smart phone and ergonomics to utilize both simultaneously with adequate control so that no audio is lost from either source. By combining the audio source and destination from a radio system via the speaker microphone, the radio audio can be effectively treated as data. That data can be stored, sent to and received from servers over the cellular broadband network and can be combined with data sent to and received from servers.

### Advantageous Effects of Invention

Most public safety agencies can effectively jump a generation in radio technology by acquiring new speaker microphones for their existing radios.

### Brief Descriptions Diagrams and Drawings

FIG. 1 illustrates the processing environment for the device.

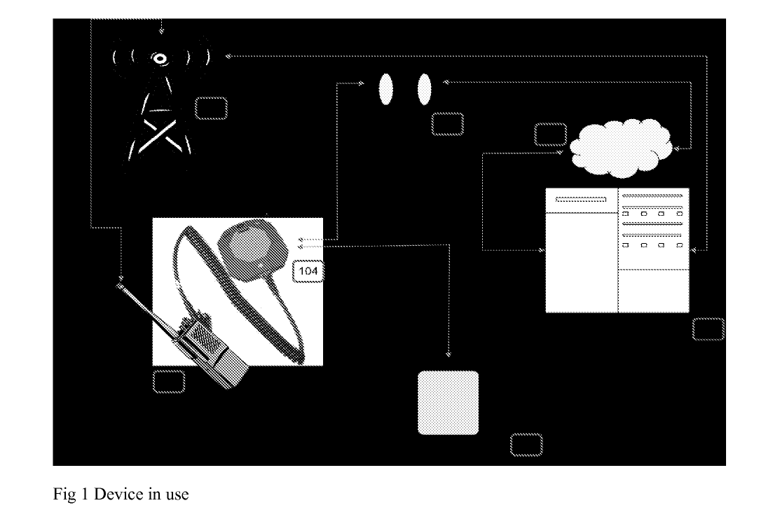

FIG. 2 shows the components connected within the device.

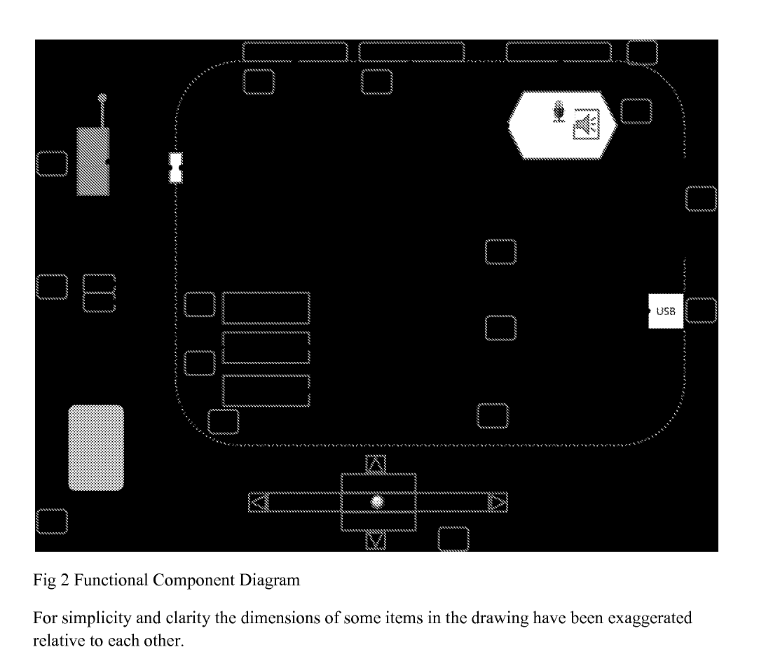

### DESCRIPTION OF EMBODIMENTS

The present invention 104 can be provided with varying cables to connect to the different models of radio. It does not depend on the radio being a portable radio 103 as shown in the drawings but will work just as well with in-vehicle mobile radios. The device may also be deployed as a wireless device where in the radio is connected via Bluetooth 210.

This device addresses the identified problems by providing wireless broadband access, integrated into the first responder's radio system. By placing the broadband modem and processor in the speaker/microphone it has access to the radio audio and thus can be seamlessly integrated into virtually any radio system. The wireless broadband 102 will support access to various data servers 106: a VOIP server that can provide alternate (additional) access to audio, a data server that can record sensor readings coming from the responder or even from his environment (automobile, fire temp, gas or radiation sensors), and provide data to/from the existing police, fire, or medical data systems . The device will support voice commands in addition to control buttons and will include text to voice from received data (auto license plate check; responding with Owner name and address). The device contains an encryption chip to allow the users to choose to utilize encrypted data between the device and the servers.

With the device a responder can talk to his team members over the radio while monitoring command over the VOIP broadband connection. Conversely a Fire Sector Lead can establish a full duplex (hands free) connection over broadband 104/101 to his team while communicating with Fire Command on his radio 103.

Because the device has a personal network (pnet) 211; sensors attached to the SWAT or Fire team members, can communicate to the device for re-transmitting the vital statistics: body temperature, pulse, heart (EKG), and air remaining in tank, to command throughout an operation.

Integration of the wireless broadband device into the radio system supplements the coverage area of a public safety radio system 100 with the coverage area of the 3G/4G 101 provider. When both the radio and the VOIP connections are carrying the same audio the user can pick whichever audio has the best quality.

As indicated above the device allows the user to access multiple audio paths simultaneously over a single device. The user can select audio source(s) and destination(s). Input audio can be from a broad band VOIP source or the LMR. Audio Output can be directed to either device or both as long as they are not on the same radio frequency.

When the user is monitoring multiple talk paths it is inevitable that audio collisions will occur. All received audio is stored on a micro flash 213 and the user is notified that audio is waiting via a light on the display 209. Upon demand a user can replay received audio.

The device provides optional on demand hands free full duplex audio capability for emergency situations. Depressing the emergency button 205 puts the user into a hands free mode in which all voice audio is transmitted as data to an audio server. This allows support/backup personnel to monitor the situation while communicating with each other on an alternate talk path (the radio).

The device provides the ability to track location. The device periodically communicates the GPS coordinates to a data server. Location reporting can be initiated by Voice command or by a remote command sent via the data server.

The device optionally links (via usb 214, blue tooth 211, or WiFi 212) to smart phones, tablets, notebooks, laptops, . . . 105 in order to provide data for remote device installed applications or for direct display: html from the processor.

The device optionally utilizes available wireless network 212 connectivity to increase throughput and minimize connection cost.

The device optionally provides broadband access to WiFi 212 enabled devices.

The device improves interoperability: responders are now sharing a common frequency (the 3G/4G providers radio frequency) regardless of the frequency utilized by the LMR. All responders with a turtle can be connected to the talk path appropriate to the responder's assignment. As a highway patrolman travels the highway his device can access the contact information for the local sheriff and/or local municipal police so that upon demand: “Command: Contact Local Police” the system can connect the patrolman to the VOIP device for the local police department dispatch.

The device improves response management of an incident by providing multiple talk paths regardless of the number of licensed frequencies held by the responding agencies and responsible jurisdictions.

The device enables the responder in the field to select the audio to monitor as well as the talk path to use.

The device enables hands free full duplex audio between (Fire or SWAT) team members while providing Fire/Police Command access over the LMR.

Thus the device effectively extends the life of existing radio systems by allowing any radio system to jump directly to LTE without significant investment.

A responder using the embedded camera can photograph a scene, evidence, or even record video to be transmitted to command.

### INDUSTRIAL APPLICABILITY

Utility companies pass maintenance documents via the broadband interface to the field personnel on demand based on the problem identied once the personnel is on site. These documents can be converted text to speach or transmitted for display to a tablet or pc.

Medical personnel can pass patient monitor readings and injury images to trauma personnel while enroute to the trauma center.

Law enforcement can retrieve wants and warrents, drivers license, auto license, and other information even when they are away from the MDT in their vehicle.

Fire personnel can attach sensors that are monitored by command to insure the safety of personnel. The procedures for hazardous material identification can be accessed and followed interactivily.

### CITATION LIST

### Patent Literature

U.S. Pat. No. 7,091,851 B2 Mason et al.

This patent specifies a speaker microphone accessory that dynamically creates a mesh network for public safety incident response use. While it does provide sensor and positioning data that will also be available via this invention this invention simply uses the existing commercial cellular data network that is publically available in addition to the users own Land Mobile Radio network and does not attempt to create a network.

US20070111754 A1 Marshall et al.

This patent provides for a speaker microphone that enables data collection and storage but does not utilize a cellular data modem for store and forward of stored data.

US20040192372 A1 Richards et al.

This patent defines an interface to connect an external device such as a cell phone where as our invention adds a processor and data modem to an existing accessory (a speaker microphone) and therefore does not require a separate interface as specified in this patent. Rather than adding a communication device as an accessory we are turning an accessory into a communication device something neither invisioned nor obvious from the US20040192372 A1. In addition the U.S. Pat. No. 7,091,851 referenced above is also for a speaker microphone with similar functions granted after US20040192372.

US20060262800 A1 and US20060262771 A1 Martinez et al.

This patent provides the some of the same functions as provided in this invention however they are provided inside a land mobile radio rather than in an accessory capable of providing the functionality to any land mobile radio

1. A speaker microphone comprising a processor configured to provide communication with a cellular data network.

2. A speaker microphone in accordance with claim 1 wherein the cellular data network communication comprises a cellular radio modem.

3. A speaker microphone in accordance with claim 1 further comprising a user interface configured to receive a user input to select one of the communication paths: over either a connected Land Mobile Radio (LMR) or the cellular data network portion.

4. A speaker microphone in accordance with claim 1 further comprising a processor configured to automatically select one of the LMR communication connection and cellular data network communication for communication of LMR content.

5. A speaker microphone in accordance with claim 1 further comprising a processor configured to automatically select one of the LMR communication portion and cellular data network portion for communication of LMR content based on at least one of an operating condition, a user setting and a predetermined setting.

6. A speaker microphone in accordance with claim 1 further comprising a display configured to identify a selected communication network and when the cellular data network is selected the selected conference (talk path).

7. A speaker microphone in accordance with claim 1 further comprising a housing having an LMR cable to connect the speaker microphone to the LMR

8. A speaker microphone in accordance with claim 1 further comprising Bluetooth personal network capability to connect the speaker microphone to the LMR

9. A speaker microphone in accordance with claim 1 further comprising a second Bluetooth personal network capability to connect the speaker microphone to Bluetooth enabled Sensors that are within range of the speaker microphone.

10. A speaker microphone in accordance with claim 9 with a processor and memory capable of storing received sensor data.

11. A speaker microphone in accordance with claim 9 with a processor capable of identifying the sensor readings and aggregating, summarizing, or monitoring for change.

12. A speaker microphone in accordance with claim 11 with a processor capable of determining based on stored rules and configuration when and to where sensor readings need to be forwarded.

13. A speaker microphone in accordance with claim 11 with a processor capable of converting the sensor readings to packetized digital data for transmission over the cellular data network to an enabled data server.

14. A speaker microphone in accordance with claim 1 with a processor and memory capable of storing received audio.

15. A speaker microphone in accordance with claim 11 with a processor capable of replaying selected audio.

16. A speaker microphone in accordance with claim 1 wherein the processor is configured to encapsulate LMR content using a packet switching protocol when communicating using the cellular data network communication modem.

17. A speaker microphone in accordance with claim 1 wherein the processor is configured to allow at least one of end-to-end encryption and end-to-end digital encoding with at least one other LMR unit.

18. A speaker microphone in accordance with claim 1 with a processor capable of receiving and processing voice commands.

19. A speaker microphone in accordance with claim 1 with the capability of providing a broadband hotspot.

20. A speaker microphone in accordance with claim 1 with the capability of passing received or stored data to a connected device for display.
